(19) United States
(12) Patent Application Publication
(10) Pub. No.: US 2008/0076291 A1
(43) Pub. Date: Mar. 27, 2008

(54) Electrical plug retainer

(75) Inventors: Carrel W. Ewing, Reno, NV (US); James P. Maskaly, Sparks, NV (US); Andrew J. Cleveland, Reno, NV (US)

Correspondence Address: HOLLAND & HART, LLP, P.O BOX 8749, DENVER, CO, 80201, US

(73) Assignee: Server Technology, Inc.

(21) Appl. No.: 11/483,135

(22) Filed: Jul. 6, 2006

(51) Int. Cl. H01R 13/62

(52) U.S. Cl. 439/373

(57) ABSTRACT

Embodiments of electrical plug retainers for use with an electrical device are disclosed herein. According to one exemplary embodiment, an electrical plug retainer for an electrical device can comprise an electrical cord clamp having a first bracket movably coupled to a second bracket. The first bracket can be selectively movable between a closed position and an open position. The clamp can also include a locking mechanism selectively engageable with the first and second brackets to maintain the first bracket in the closed position. The plug retainer further includes connector or spacer arms coupled to the electrical cord clamp at a first end and coupleable to an electrical device at a second end generally opposite the first end. When the first bracket is in the closed position, a portion of at least one electrical cord can be fixedly positionable between the first and second brackets.

### FIELD

This invention relates to accessories for an electrical device, and in particular, an electrical plug retainer for an electrical device.

### BACKGROUND

Electrical devices, such as computers, servers, printers, monitors, televisions, audio equipment and power distribution devices have hardware interfaces, such as ports, sockets, terminals and outlets, configured to receive the plug, i.e., interface mating portion or connector, of an electrical cord used to communicating with, or supply power to, other electrical devices via the cord.

An example of such an electrical device is a power distribution unit (PDU) configured to supply power to other electrical devices, components or equipment via one or more power outlets or receptacles. Electrical connectivity between the PDU and an electrical device is established by removably inserting a power cord plug of the electrical device into an active outlet of the PDU.

Commonly, a PDU has a plurality of power outlets disposed on the PDU in relatively close proximity for supplying power to a plurality of electrical devices or equipment. In other words, in operation, a single PDU can have a plurality of plugs and associated power cords extending from the outlets. Often, an operator may be required to remove an existing plug, insert a new plug, or otherwise perform operations on or near the PDU. Such operations can result in inadvertently disengaging or pulling out a plug from a respective outlet other than a desired outlet resulting in a downed electrical device.

One or more PDUs are often mounted within an electronic component rack for supplying power to electronic components housed within the rack. The electronic components are stored in relatively close proximity within the rack and each can have one or more power cords with respective plug plugged into the power outlets of the PDU. Generally, a substantial number of electronic components with an at least equal number of power cords and plugs are disposed in close proximity within the confines of the rack.

Racks generally have a limited amount of space in the rear of the rack in which the power cords are allowed to extend, which can lead to an area proximate the PDU that is severely congested with power cords and plugs. Power cord congestion can lead to problems since operators are often required to access racks via the rear of the racks near the power cords to configure, remove or add electronic devices. Such maintenance can lead to inadvertently or mistakenly pulling on or otherwise contacting one or more power cords, which can cause the power cords' plug to disengage from an outlet of the PDU. Inadvertent removal of a plug from an outlet can, of course, lead to an undesirable loss of power to an electronic device in the rack.

As with a PDU, other electrical devices can have multiple hardware interfaces with multiple electrical plugs and associated cords connected thereto or plugged therein. For example, a single computer typically has ports for connecting to the plugs of a printer cable, monitor cable, keyboard cable, network cable, internet cable, and other auxiliary device cables. With such a significant number of cables in a small area, the plugs are prone to inadvertent disconnection from the hardware interfaces, which can lead to unintended consequences.

It is therefore desirable to prevent inadvertent disengagement between the plugs of electronic cords, such as power cords, and the interfaces to which the plugs are engaged, such as the outlets of a PDU mounted within a rack.

One known plug retainer is described in U.S. Patent Application Publication No. 2005/0094357, published May 5, 2005. This retainer comprises a formed wire coupled to a PDU and being rotatable into contact with a plug. This plug retainer, however, can have certain disadvantages. For example, the retainer is only capable of retaining plugs having mouldings of a specific size and height and is not adaptable to retain plug mouldings of various manufacturers having differing sizes and heights. Further, the plug retainer can be prone to dislodging from the power plug moulding by bumping or otherwise inadvertently contacting the retainer to cause it to rotate out of contact with the plug moulding.

### SUMMARY

Described herein is an improved plug retainer that overcomes many of the disadvantages of the prior art.

According to one exemplary embodiment, an electrical plug retainer for an electrical device can comprise an electrical cord clamp having a first bracket movably coupled to a second bracket. The first bracket can be selectively movable between a closed position and an open position. The clamp can also include a locking mechanism selectively engageable with the first and second brackets to maintain the first bracket in the closed position. The plug retainer can further include connector or spacer arms coupled to the electrical cord clamp at a first end and coupleable to an electrical device at a second end generally opposite the first end. When the first bracket is in the closed position, a portion of at least one electrical cord can be fixedly positionable between the first and second brackets. In specific implementations, the plug retainer can be adapted such that more than one electrical cord is fixedly positionable between the first and second brackets.

In some implementations, the electrical device is a PDU and the electrical cord is a power cord.

In specific implementations, the first bracket can be pivotably coupled to the second bracket via a hinge mechanism, which can be integral with or coupled to the brackets. In some implementations, for example, in implementations having an integral hinge mechanism, the first bracket can comprise a tab having a generally U-shape and the second bracket can comprise a tab slot sized to receive the tab. The first bracket can be movably coupled to the second bracket via engagement between the tab and tab slot.

In certain implementations, the first bracket can comprise a first threaded aperture and the second bracket can comprise a second aperture alignable with the first threaded aperture. The locking mechanism can correspondingly comprise a fastener insertable through the second aperture and threadably engageable with the first threaded aperture.

To facilitate fixedly securing an electrical cord between the brackets, at least one of the first and second brackets can have an electrical cord receiving groove, which in some aspects can have a generally curved cross-sectional shape. To increase the frictional forces between the cord and the brackets, the cord receiving groove or can have grip enhancing features formed on the groove or attached to the groove. In specific implementations, both the first and second brackets have cord receiving grooves that are alignable with each other when the first bracket is in the closed position. When aligned, the grooves can define a space therebetween sized to receive at least one electrical cord. In some specific implementations, both the first and second brackets have each have two or more cord receiving grooves.

The improved plug retainer of the present disclosure is capable of adapting to plug mouldings having various configurations. Typically, the vertical height of the plug or plug moulding is variable between manufacturers. The improved plug retainer does not rely on contact with the plug moulding to secure the plug to an electrical device. Rather, the improved plug retainer is removably secured to a portion of the cord to which the plug is attached above, or spaced-apart from, the plug moulding. Accordingly, the height of the plug moulding does not limit the ability of the improved plug retainer to retain the plug in an interface of the electrical device.

The improved plug retainer overcomes the disadvantages of the prior art by resisting disengagement from the cord due to inadvertent contact. In other words, when secured in the first position by the locking mechanism, the plug retainer is configured to remain engaged with the cord unless the locking mechanism is manually and intentionally loosened.

According to another exemplary embodiment, an electronic equipment rack assembly can include an electronic equipment rack for housing electronic equipment and a PDU mounted to the rack. The assembly can also include an electrical plug retainer coupled to the unit. The PDU can be in power receiving communication with at least one power source and have a plurality of power outlets capable of being in power supply communication with electronic equipment mounted within the rack via electrical cords. Power is supplied from the PDU to the electronic equipment via electrical cords having plugs in engagement with the power outputs. The electrical plug retainer can be coupled to the PDU and be selectively securable to at least one of the electrical cords of the various electronic equipment.

In specific implementations, the PDU can comprise at least one pair of power outlets disposed laterally adjacent each other. The electrical plug retainer can be selectively securable to two electrical cords having plugs in engagement with the at least one pair of power outlets.

In one exemplary embodiment of a method for retaining a plug of an electrical cord in engagement with an interface of an electrical device, the method can comprise coupling a plug retainer having first and second brackets to the electrical device. The method can also include clamping a portion of the cord between the first and second brackets of the plug retainer. In specific implementations, the portion of the cord can be located a distance away from the cord plug. Additionally, the method can include maintaining said portion of the cord in a spaced apart relationship with the power distribution device. In specific implementations, the electrical device is a power distribution unit and the electrical cord is an electrical power cord.

In some implementations, the plug retainer can comprise a lock mechanism coupleable to the first and second brackets and clamping the portion of the cord between the first and second brackets can include locking the lock mechanism. In specific implementations, the lock mechanism can include an adjustable fastener threadably engageable with the first and second brackets and locking the lock mechanism can include tightening the fastener to the first and second brackets.

In some implementations, the first bracket is hingedly coupled to the second bracket and movable between an open position and a closed position relative to the second bracket. In at least some of these implementations, clamping the portion of the cord between the first and second brackets of the plug retainer can comprise moving the first bracket from the open position to the closed position. Yet in some implementations, clamping can include clamping a portion of at least a first and second cord between the first and second brackets of the plug retainer.

It is intended that the above method steps, and other method steps described herein, need not be performed in any particular order.

It is to be understood that the foregoing is merely a brief summary of some features or aspects of the invention or preferred embodiments. There are other aspects or features that will become more apparent with reference to the following description.

### SUMMARY OF THE DRAWINGS

FIG. 1 is a partial perspective view of an exemplary embodiment of an electrical plug retainer attached to a power distribution device.

FIG. 2 is a front elevational view of the electrical plug retainer of FIG. 1 in the “closed” or cord holding position.

FIG. 3 is a front elevational view of the electrical plug retainer of FIG. 1 in the “open” or cord releasing position.

FIG. 4 is a partial perspective view of an exemplary embodiment of an electrical plug retainer for retaining two plugs attached to a power distribution device.

FIG. 5 is a perspective view of the electrical plug retainer and power distribution device of FIG. 4 mounted within an electronic equipment rack.

### DETAILED DESCRIPTION OF THE PREFERRED EMBODIMENTS

Exemplary embodiments of a plug retainer for holding a plug in engagement with a hardware interface of an electrical device are described herein. The plug is electrically coupled or attached to an associated cord, which is capable of transmitting electrical signals or power to another electrical device. Although it is common in the art to define a cord or cable to include an interface mating end, or plug, portion that is attached to an electrically conductive wire portion, for purposes of clarity in describing the features of the present disclosure, as used herein, unless otherwise noted, cord refers only to the electrically conductive wire portion and does not include or refer to the mating end or plug portion. In other words, as used herein, electricity or electric signals are transferred through the cord and the plug coupled to the cord to supply power or transmit communications to an electrical device.

The plug retainer comprises a cord securing mechanism coupled to the electrical device that selectively secures one or more cords such that the plugs of the respective cords are retained in engagement with the electrical device.

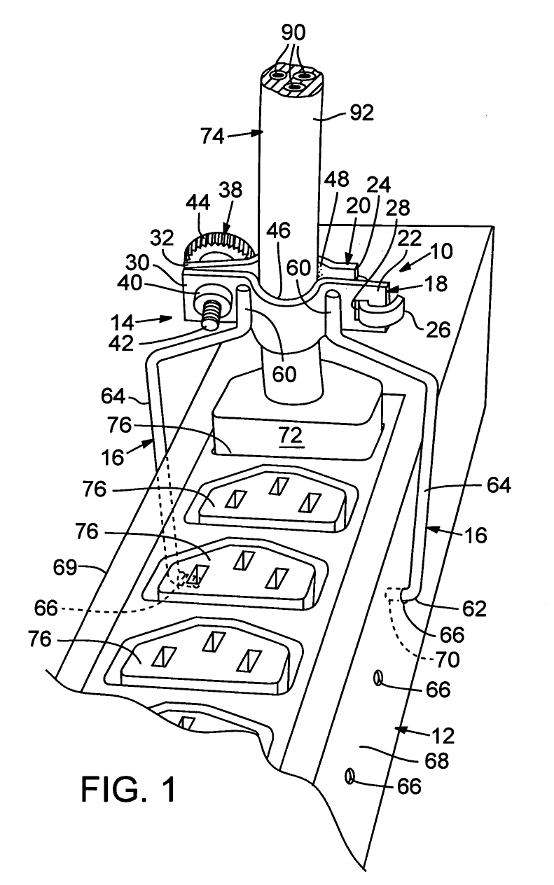

Referring to FIG. 1, an exemplary embodiment of a plug retainer 10 is shown coupled to an electrical device, which in this embodiment, is a power distribution device, e.g., PDU 12. The plug retainer 10 comprises a cord securing mechanism 14 coupled to electrical device connecting portions, such as spaced apart connecting arms 16.

The cord securing mechanism 14 comprises a first bracket 18 and a second bracket 20 and is configured to removably secure a portion of one or more cords between the brackets. As shown in FIG. 1, the portion of the one or more cords is a portion of the cord, such as power cord 74, above or spaced apart from the associated cord plug, such as plug 72. In some exemplary implementations, the power cord 74 can comprise one or more electrically conducting wires 90 enveloped by an insulating sleeve 92. Accordingly, the cord securing mechanism 14 is securable to or grips the insulating sleeve of the cord 74 at a location away from the plug 72.

Preferably, the brackets 18, 20 are constructed from a sheet of material having a thickness substantially less that its width and length. Although the brackets in the illustrated embodiments have a generally rectangular shape, it is recognized that in other embodiments, the brackets can have any of various shapes, such as, for example, generally circular, triangular and polygonal.

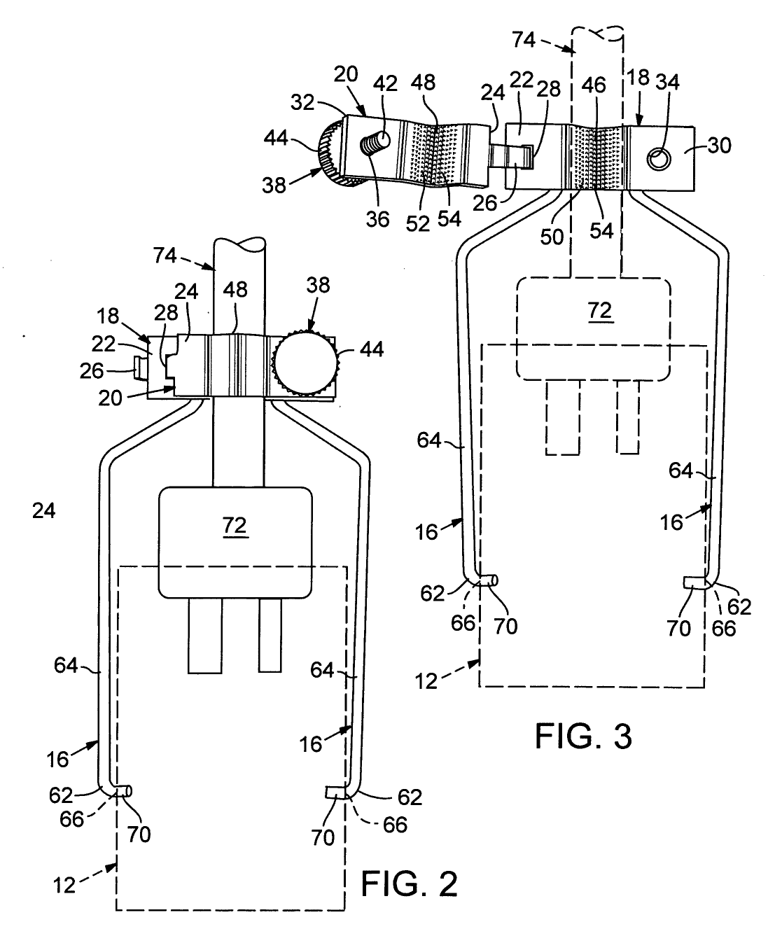

In one specific exemplary implementation, the first bracket 18 and the second bracket 20 are coupled together and movable relative to each other between a closed position (FIGS. 1 and 2) and an open position (FIG. 3). The first and second brackets 18, 20 can be coupled to each other in a hinged relationship at corresponding attached end portions 22, 24 of the brackets such that one bracket is pivotable, or otherwise movable, about its attached end portion relative to the other bracket. For example, as shown in FIG. 1, the first bracket, i.e., fixed bracket, 18 can be fixed relative to the connecting arms 16 and the second bracket, i.e., movable bracket, 20 can be movable or pivotable about its attached end portion 24 relative to the fixed bracket.

In the illustrated implementations shown in FIGS. 1-3, the hinged relationship between the first and second brackets 18, 20 is accomplished via a tab 26 extending from the attached end portion 24 of the second movable bracket and engaging a tab opening 28 formed in the attached end portion 22 of the first fixed bracket. The tab 26 is configured to extend through the tab opening 28 in the first fixed bracket 18 and maintain engagement with the opening as the second movable bracket 20 is pivoted or swiveled between the closed and open positions. As shown, the tab 26, for example, can have a generally “U,” “hook,” or arcuate shape to maintain engagement with the tab opening 28.

Although not specifically shown, the hinged or pivotable relationship between the first and second brackets 18, 20 can be accomplished by conventional hinges, such as, for example, pinned, spring and fabric hinges, attached to the attached end portions 22, 24 of the brackets.

Further, although the first bracket 18 is shown and described as being fixed relative to the arms 16 and the second bracket 20 being movable relative to the first bracket 18, it is recognized that the second bracket 20 can easily be fixed relative to the arms 16 and the first bracket 18 can be movable relative to the second bracket.

The first and second brackets 18, 20 each include separable end portions 30, 32, respectively, opposite the attached end portions 22, 24. The separable end portions 30, 32 can be movable towards and apart from each other. The separable end portions 30, 32 can also be fixedly positioned in relatively close proximity to each other to secure a cord or wire between the first and second brackets 18, 20 and detached to allow the cord or wire to be removed from the plug retainer 10 as will be described in more detail below.

As perhaps best shown in FIG. 3, in some exemplary implementations, the separable end portions 30, 32 each include a fastener receiving opening 34, 36, respectively, for receiving a fastener, such as fastener 38.

In the exemplary implementations, the fastener receiving opening 34 of the first bracket 18 is sized to receive a threaded nut, or insert, 40 in press-fit engagement with the opening 34 to facilitate tightening of the second bracket to the first bracket 18. In some implementations, the nut 40 is coupled to the first bracket 18 such that a portion of the nut extends from an outer surface of the first bracket. The fastener receiving opening 36 in the second bracket 20 can be alignable with the fastener receiving opening 34 in the first bracket 18 when the second bracket is in or proximate to the closed position. The fastener receiving opening 36 can be threaded or unthreaded.

The fastener 38 can comprise, for example, a shaft having a threaded portion 42 configured to threadably engage the fastener receiving opening 34 of the first bracket 18 and threads of the nut 40. In implementations where the fastener receiving opening 36 is threaded, the threaded portion 42 of the fastener 38 is also configured to threadably engage the opening 36 of the second bracket 20. In some implementations, the fastener 38 can also include a user engaging portion 44 for facilitating manual tightening of the fastener without the need for tools. The user engaging portion 44 can be disc-shaped with a series of grooves and ridges formed in the outer circumferential surface of the user engaging portion. The fastener shaft can also have an unthreaded portion intermediate the threaded portion and the user engaging portion. In other implementations, the fastener can be a screw that can be tightened through use of a conventional tool, such as a screwdriver or Allen wrench.

Although not shown, the separable end portions 30, 32 can be coupled together using a coupling configuration, or attachment mechanism, other than a screw-like fastener and nut as described above. For example, the separable end portions 30, 32 can be coupled together using an attachment mechanism, such as a snap-fit fastening system, latching mechanism or clip arrangement, commonly known in the art. In one implementation, the attachment mechanism comprises a latching mechanism having a cam or lever coupled to the first and second brackets. The cam or lever can be rotated in a first direction to lock the second bracket in the closed position and rotated in a second direction opposite the first direction to unlock the second bracket to allow the second bracket to be moved into the open position. The attachment mechanism can be, for example, integral with, fixedly attached, or removably attached to the end portions 30, 32. Preferably, the attachment mechanism is adjustably tightenable to accommodate cords of varying shapes and sizes.

Referring again to FIG. 3, in some exemplary embodiments, one or both of the brackets 18, 20 can include a cord receiving portion centrally located on the respective brackets, i.e., intermediate the attached end portions 22, 24 and separable end portions 30, 32, respectively. For example, as shown in the illustrated embodiments, the first bracket 18 can include a cord receiving portion, e.g., cord receiving channel, or groove, 46, and the second bracket 20 can include a cord receiving portion, e.g., cord receiving channel, or groove, 48.

In exemplary embodiments, the cord receiving channels 46, 48 can extend the entire height of the brackets, i.e., vertically from a bottom edge to a top edge of the first and second brackets 18, 20, respectively, as shown in FIG. 3. Each channel 46, 48 can have a generally semi-circular, “U,” or arcuate shape, although in other embodiments, the channels can formed having other shapes, such as, for example, rectangular and triangular. The cord receiving channels 46, 48 can be substantially alignable with each other when the movable bracket 20 is in, or proximate to, the closed position as shown in FIG. 1. Further, referring to FIG. 3, the inner surfaces 50, 52 of the cord receiving channels 46, 48, respectively, can have cord gripping features formed thereon or attached thereto. For example, in some implementations, the cord gripping features can be a pattern 54 etched into the inner surfaces, such as a series of ridges and grooves in a cross-hatched pattern. In other implementations, a material, such as rubber, can be attached to the inner surfaces to enhance the frictional forces between the brackets and a cord disposed between the brackets.

Although the illustrated embodiments show cord receiving portions comprising centrally located cord receiving channels, it is recognized that in some embodiments, the cord receiving portions can comprise generally semi-circular, “U,” or arcuate shaped cord receiving channels that extend the entire length of the brackets, i.e., horizontally from respective separable portions to respective attached portions of the first and second brackets. In other words, the brackets themselves can have a generally semi-circular, “U,” or arcuate shape. Alternatively, the brackets themselves can have another shape, such as rectangular or triangular.

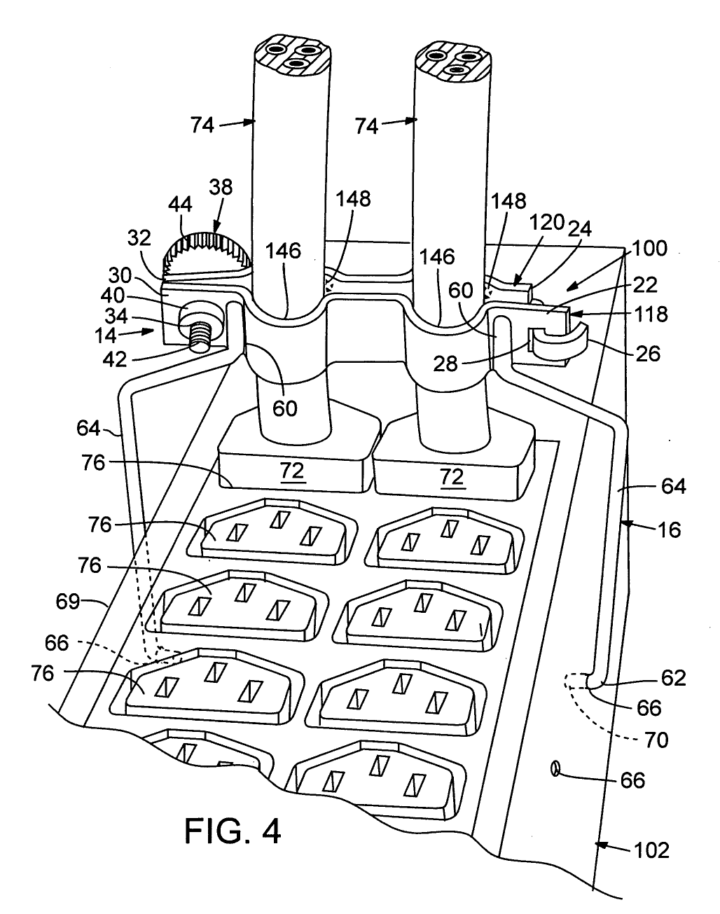

Although the illustrated embodiments show a single cord receiving channel formed in each of the brackets 18, 20, in some embodiments, the brackets 18, 20 can each have two or more spaced-apart channels to accommodate a PDU having multiple outlets in a laterally side-by-side arrangement (see, e.g., FIG. 4).

The electrical device connecting portions of the plug retainer 10 are configured to couple the cord securing mechanism 14 to an electrical device. In specific exemplary implementations, the electrical device connecting portions are spaced apart connecting arms, or spacers, 16 attached to the first bracket 18 of the cord securing mechanism 14.

Each arm 16 can comprise an elongate length of an at least partially rigid material having a first end portion 60, a second end portion 62 opposite the first end portion and a middle portion 64 extending intermediate the first and second end portions. The first end portions 60 are fixedly secured to the first bracket 18 by conventional techniques, such as, for example, welding, soldering, adhering, or fastening. Alternatively, it is recognized that each arm 16 can be formed as a one-piece monolithic construction with a respective bracket. A first length of the middle portions 64 can extend downwardly away from the first bracket at an angle relative to vertical and a second length can extend downwardly from the first length in a substantially vertical direction as shown in FIGS. 2 and 3. In some implementations, the arms 16, more specifically, the middle portion of the arms, can have a generally arcuate or “U” shape. The second end portions 62 extend from the middle portions 64 and are coupled to the PDU 12. In some implementations, the arms 16 and the first bracket 18 can be formed of a one-piece monolithic construction, such as by using molding techniques.

In the illustrated embodiments, the connecting arms 16 couple the cord securing mechanism 14 to the PDU 12 by engaging apertures 66 penetrating opposing sides 68, 69 of the PDU. Each second end portion 62 can have an electrical device engaging portion 70 extending substantially transversely relative to the middle portion 64 that engages the apertures 66. As shown, when coupled to the PDU 12, the arms 16 maintain the cord securing mechanism 14 in spaced-apart relationship above the plug 72 and the PDU. This allows the plug retainer 10 to be adaptable to various plug heights and sizes.

As shown in FIG. 3, in the illustrated embodiment, when the electrical plug retainer 10 is not engaged with the PDU 12, the second end portions 62 of the arms 16 are pre-disposed, i.e., biased, at a first distance apart from each other. The plug retainer 10 can be coupled to the PDU 12 by applying outwardly and oppositely directed pressures to the arms 16 to move the second end portions 62 of the arms apart such that the second end portions are disposed at a second distance apart from each other that is just larger than a distance between the sides 68, 69 of the PDU. The plug retainer 10 can then be re-positioned such that the PDU 12 is disposed between the respective second end portions 62 and the PDU engaging portions 70 are aligned with corresponding apertures 66 penetrating the sides 68, 69 of the PDU. In this position, the pressures being applied to the arms 16 can be removed and the PDU engaging portions 70 are urged toward each other to penetrate the apertures 66 and secure the plug retainer 10 to the PDU 12. The plug retainer 10 can also be easily removed from the PDU 12 by reapplying outwardly directed opposing pressures to the arms 16 to disengage the PDU engaging portion 70 with the apertures 66.

In implementations having a PDU 12 with multiple individual outlets or sets of side-by-side outlets (see FIG. 4) extending longitudinally along a length of the PDU, it is preferable that a respective set of apertures 66 are disposed adjacent each outlet or set of side-by-side outlets. In this manner, multiple electrical plug retainers 10 can be coupled to the PDU 12 such that each outlet or set of outlets has a corresponding electrical plug retainer for holding cords plugged into the respective outlets.

Of course, the arms 16 could be attached to the PDU 12 by any of various other attachment mechanisms commonly used in the art. For example, the electrical device engaging portions 70 of the arms 16 could have clips or snap-fit fasteners attached thereto for engaging mating components mounted to or formed in the PDU 12.

Referring back to the illustrative embodiment shown in FIG. 1, in operation, a plug 72 of cord 74 is inserted into an outlet 76 adjacent the electrical plug retainer 10. With the second movable bracket 20 in the open position as shown in FIG. 3, i.e., the separable end portion 32 of the movable bracket 20 is pivoted away from the separable end portion 30 of the fixed bracket 18, the cord 74 can be positioned proximate the cord receiving channel 46 of the fixed bracket. The movable bracket 20 is then pivoted about its attached end portion 24 from the open position toward the closed position, i.e. the separable end portion 32 of the movable bracket 20 is pivoted at least in close proximity to the separable end portion 30 of the fixed bracket 18 such that the cord 74 is disposed at least partially within the cord receiving channels 46, 48 of the fixed and movable brackets, respectively.

In implementations having an unthreaded aperture 36, the threaded portion 42 of the fastener 38 can be inserted through the aperture and rotated to threadably engage the nut 40 coupled to the first bracket 18. Alternatively, in implementations having a threaded aperture 36, the fastener 38 can be positioned and rotated to first threadably engage the fastener receiving aperture 36 and then threadably engage the nut 40. When threadably engaged with the nut 40, rotation of the fastener 38 moves the second bracket 20 toward the first bracket 18 until the inner surfaces 50, 52 of the cord receiving channels 46, 48, respectively, are tightened against the cord 74. With the brackets 18, 20 applying opposing pressures to the cord 74, the cord is effectively clamped and immovably retained by the brackets. As can be recognized, the cord gripping features 54 can facilitate enhanced retention of the cord by engaging the outer surface of the cord. With the cord 74 immovably retained by the electrical plug retainer 10 and the plug retainer secured to the PDU 12, the plug retainer prevents the plug 72 from disengaging or being unplugged from the outlet 76 when subjected to pulling or manipulation, or otherwise movement, of the cord 74.

In the illustrated implementation, when desired, the plug 72 can be removed from the outlet 76 by: (1) rotating the fastener 38 in a direction opposite the direction rotated to tighten the brackets 18, 20 until the separable end portion 32 of the second bracket 20 is decoupled from the separable end portion 30 of the first bracket 18; (2) pivoting the second bracket into the open position; and (3) pulling the plug out of the outlet.

Referring to FIG. 4, and according to an alternative embodiment, a plug retainer 100 can be coupled to a PDU 102 having two side-by-side columns of outlets. In FIG. 4, the same reference numbers are used to denote features similar to those in FIG. 1 except as otherwise noted. Two cords 74 with respective plugs 72 are plugged into side-by-side outlets 76 such that the cords and plugs are arranged in a side-by-side relationship. The plug retainer 100 is similar to plug retainer 10 except that the plug retainer 100 is configured to secure two cords 74 instead of one. More specifically, the brackets 118, 120 of the cord securing mechanism 114 of the retainer 100 have an overall length that is greater than the overall length of the brackets 18, 20 of the retainer 10. Further, each bracket 118, 120 has two cord receiving channels 146, 148, respectively, for accommodating the two cords 74.

It is recognized that in some applications, a PDU may have more than two outlets disposed in a side-by-side relationship and more than two cords plugged into the outlets. Accordingly, although not specifically shown, in some embodiments, the plug retainer can be configured to retain more than two cords, such as by having more than two plug retaining channels or grooves in the brackets.

In some implementations, the electrical plug retainers 10, 100 are made from a metal, such as aluminum or steel. In other implementations, the electrical plug retainers 10, 100 can be made from a substantially rigid and durable plastic material.

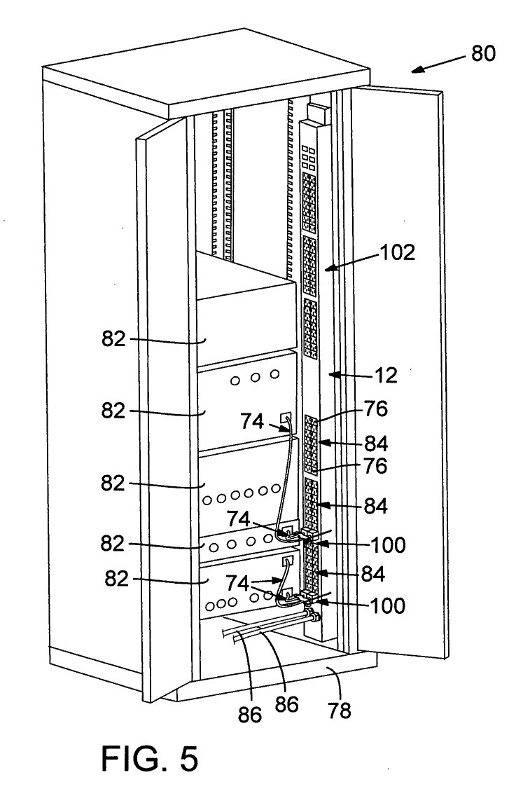

Referring to FIG. 5, according to one embodiment, one or more electrical plug retainers, such plug retainers 100 shown in FIG. 4, can be used in conjunction with a PDU, such as PDU 102, vertically mounted in a rear portion 78 of an electrical equipment rack 80. The rack can be any of various known racks, such as a rack manufactured by American Power Conversion Corp. of West Kingston, R.I. The PDU 102 receives electrical power via power input wires 86 and is configured to supply power to one or more electronic devices 82 housed in the rack via multiple side-by-side columns 84 of outlets 76. Often, a plurality of electronic devices 82 is mounted in the rack 80 with each device having one or more power cords 74 plugged into the outlets 76 of the PDU 102.

Although only four power cords 74 are shown plugged into the PDU 102, it is recognizable that many more power cords can be plugged into the PDU, which can place a significant number of power cords in relatively close proximity to each other. Further, operators are often required to access racks, such as rack 80, via a rear portion of the racks, such as rear portion 78, near the plurality of cords to configure, remove or add electronic devices. Such maintenance being performed in close proximity to the cords subject the power cords to inadvertent or mistaken removal, which of course can lead to power loss to the electronic devices in the rack. Accordingly, electronic plug retainers, such as plug retainers 10, 100 can be highly advantageous in an electronic equipment rack environment to prevent such inadvertent disengagement of power plugs from a PDU.

Although the illustrated embodiments show a plug retainer coupled to a PDU to retain an electrical power cord in engagement with an outlet of the PDU, it is recognized that the same principles and features described above can be applied to any electrical device having an interface for receiving a plug portion of an electrical power or communications cord to retain the plug portion in engagement with the interface. For example, in one embodiment, an electrical plug retainer, such as plug retainer 10, can be coupled to a computer proximate the computer's printer port. A portion of a printer cord with a connector connected to the printer port can be removably secured by the cord securing mechanism 14 of the plug retainer 10 to retain the cord connector (plug) in engagement with the port.

In view of the many possible embodiments to which the described principles may be applied, it should be recognized that the illustrated embodiments are only preferred examples and should not be taken as limiting the scope of the application. Rather, the scope is defined by the following claims. We therefore claim as our invention all that comes within the scope and spirit of these claims.

We claim:

1. An electrical plug retainer for an electrical device, comprising in combination:
an electrical cord clamp comprising:
(A) a first bracket movably coupled to a second bracket, the first bracket being selectively movable between a closed position and an open position, and
(B) a locking mechanism selectively engageable with the first and second brackets to maintain the first bracket in the closed position; and
connector arms coupled to the electrical cord clamp at a first end and coupleable to an electrical device at a second end generally opposite the first end;
wherein when the first bracket is in the closed position, a portion of at least one electrical cord is fixedly positionable between the first and second brackets.

2. The electrical plug retainer of claim 1, wherein the first bracket is pivotably coupled to the second bracket, and the first bracket is selectively pivotable between the closed position and the open position.

3. The electrical plug retainer of claim 1, wherein the electrical cord clamp is securable to the at least one electrical cord portion at a location away from a plug of the at least one electrical cord.

4. The electrical plug retainer of claim 3, wherein the first bracket comprises a first threaded aperture and the second bracket comprises a second aperture alignable with the first threaded aperture, and wherein the locking mechanism comprises a fastener insertable through the second aperture and threadably engageable with the first threaded aperture.

5. The electrical plug retainer of claim 1, wherein at least one of the first and second brackets comprises an electrical cord receiving groove having a generally curved cross-sectional shape.

6. The electrical plug retainer of claim 5, wherein a surface of the cord receiving groove comprises grip enhancing features.

7. The electrical plug retainer of claim 1, wherein the first bracket comprises at least a first electrical cord receiving groove and the second bracket comprises at least a second electrical cord receiving groove, and wherein when the first bracket is in the closed position, the at least first electrical cord receiving groove is alignable with the at least second electrical cord receiving groove to define a space therebetween sized to receive at least one electrical cord.

8. The electrical plug retainer of claim 7, wherein a surface of the cord receiving groove comprises grip enhancing features.

9. The electrical plug retainer of claim 7, wherein the at least one electrical cord is a first electrical cord, and wherein the first bracket comprises at least a third electrical cord receiving groove adjacent the first electrical cord receiving groove and the second bracket comprises at least a fourth electrical cord receiving groove adjacent the second electrical cord receiving groove, and wherein when the first bracket is in the closed position, the at least third electrical cord receiving groove is alignable with the at least fourth electrical cord receiving groove to define a space therebetween sized to receive at least a second electrical cord.

10. The electrical plug retainer of claim 1, wherein when the first bracket is in the closed position, a portion of at least two electrical cords is fixedly positionable between the first and second brackets.

11. The electrical plug retainer of claim 1, wherein the first bracket is movably coupled to the second bracket via a hinge mechanism.

12. The electrical plug retainer of claim 1, wherein the first bracket comprises a tab having a generally U-shape and the second bracket comprises a tab slot sized to receive the tab, wherein the first bracket is movably coupled to the second bracket via engagement between the tab and the tab slot.

13. The electrical plug retainer of claim 1, wherein a portion of at least two electrical cords are fixedly positionable between the first and second brackets.

14. The electrical plug retainer of claim 1, wherein the electrical device is a power distribution unit and the electrical cord is an electrical power cord.

15. An electronic equipment rack assembly, comprising in combination:
an electronic equipment rack for housing electronic equipment;
a power distribution unit mounted to the electronic equipment rack, the power distribution unit being in power receiving communication with at least one power source and having a plurality of power outlets capable of being in power supply communication with electronic equipment via electrical cords; and
an electrical plug retainer coupled to the power distribution unit and selectively securable to at least one of the electrical cords, the electrical plug retainer comprising:
(A) a clamp having a first bracket movably coupled to a second bracket, the first bracket being movable between an electrical cord securing position and an electrical cord releasing position, wherein when the first bracket is in the electrical cord securing position, a portion of at least one electrical cord is fixedly positionable between the first and second brackets, and wherein the clamp further comprises a locking mechanism selectively engageable with the first and second brackets to maintain the first bracket in the electrical cord securing position; and
(B) spacer arms coupled to the electrical cord clamp at a first end and to the power distribution unit at a second end generally opposite the first end.

16. The electronic equipment rack assembly of claim 15, wherein the power distribution unit comprises at least one pair of power outlets disposed laterally adjacent each other, and wherein the electrical plug retainer is selectively securable to two electrical cords having plugs in engagement with the at least one pair of power outlets.

17. The electronic equipment rack assembly of claim 15, wherein the electrical cord clamp is securable to the at least one electrical cord portion at a location away from a plug of the at least one electrical cord.

18. The electronic equipment rack assembly of claim 15, wherein the first bracket is movably coupled to the second bracket via a hinge mechanism.

19. The electronic equipment rack assembly of claim 15, wherein the first bracket comprises a tab having a generally U-shape and the second bracket comprises a tab slot sized to receive the tab, wherein the first bracket is movably coupled to the second bracket via engagement between the tab and the tab slot.

20. The electronic equipment rack assembly of claim 15, wherein at least one of the first and second brackets comprises an electrical cord receiving groove having a generally curved cross-sectional shape.

21. The electronic equipment rack assembly of claim 20, wherein a surface of the cord receiving groove comprises grip enhancing features.

22. The electronic equipment rack assembly of claim 15, wherein a portion of at least two electrical cords are fixedly positionable between the first and second brackets.

23. A method for retaining a plug of an electrical cord in engagement with an interface of an electrical device, the method comprising:
coupling a plug retainer having first and second brackets to the electrical device;
clamping a portion of an electrical cord between the first and second brackets of the plug retainer; and
maintaining said portion of the electrical cord in a spaced apart relationship with the electrical device.

24. The method of claim 23, wherein clamping comprises clamping a portion of the electrical cord at a location away from a plug of the electrical cord between the first and second brackets of the plug retainer.

25. The method of claim 23, wherein the plug retainer comprises a lock mechanism coupleable to the first and second brackets, and wherein clamping the portion of the electrical cord between the first and second brackets comprises locking the lock mechanism.

26. The method of claim 25, wherein the lock mechanism comprises an adjustable fastener threadably engageable with the first and second brackets, and wherein locking the lock mechanism comprises tightening the fastener to the first and second brackets.

27. The method of claim 23, wherein the first bracket is hingedly coupled to the second bracket and movable between an open position and a closed position relative to the second bracket, wherein clamping the portion of the electrical cord between the first and second brackets of the plug retainer comprises moving the first bracket from the open position to the closed position.

28. The method of claim 23, wherein the electrical cord is a first electrical cord, and wherein clamping comprises clamping a portion of at least a second electrical cord between the first and second brackets of the plug retainer.

29. The method of claim 23, wherein the electrical device is a power distribution unit and the electrical cord is an electrical power cord.
